(19) United States
(12) Patent Application Publication
(10) Pub. No.: US 2024/0160980 A1
(43) Pub. Date: May 16, 2024

(54) ESTIMATING SIGNAL FROM NOISE IN QUANTUM MEASUREMENTS

(71) Applicant: Dell Products L.P., Round Rock, TX (US)

(72) Inventors: Miguel Paredes Quiñones, Campinas (BR); Rômulo Teixeira de Abreu Pinho, Niterói (BR)

(21) Appl. No.: 18/345,505

(22) Filed: Jun. 30, 2023

Related U.S. Application Data
(60) Provisional application No. 63/383,333, filed on Nov. 11, 2022.

(51) Int. Cl. G06N 10/20; G06N 10/80

(52) U.S. Cl. CPC G06N 10/20; G06N 10/80

(57) ABSTRACT

Generating clean signals from the execution of quantum circuits is disclosed. A quantum circuit may be executed a number of times (k times) that is less than a specified number of times. The noisy output after k executions is iteratively processed by a machine learning model that is configured to gradually separate a clean or usable output from the noisy output. This allows a reliable output to be determined from fewer circuit executions.

### FIELD OF THE INVENTION

Embodiments of the present invention generally relate to quantum computing and to orchestrating quantum workloads. More particularly, at least some embodiments of the invention relate to systems, hardware, software, computer-readable media, and methods for estimating signal from noise in quantum measurements.

### BACKGROUND

Quantum computing systems provide the ability to perform various applications or operations more quickly and efficiently compared to classical computing systems. However, there are various limiting factors to consider. One of the limiting factors in quantum computing systems is the presence of noise across the quantum computing system.

In addition to the probabilistic nature and non-deterministic nature of quantum computations, noise impacts the non-determinism of quantum circuit results. To mitigate the effect of noise, quantum algorithms or circuits are executed many (e.g., hundreds or thousands) of times so that the probability distributions of the outputs of circuit executions reveal themselves or become more defined. This process, however, is costly, and the right number of executions or shots needed to obtain or separate signal from noise is unknown prior to circuit execution.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of orchestrating the execution of quantum jobs and of executing quantum jobs;

FIG. 2 discloses additional aspects of executing a quantum job in a manner that accounts for recurrent patterns;

FIG. 3 discloses aspects of estimating a distribution or output of a quantum computing system using a model trained with data related to the circuit, the quantum system used to execute the circuit, and/or partial outputs of the quantum system;

FIG. 4A discloses aspects of generating a training dataset for training a model to generate a clean signal from an input noisy signal;

FIG. 4B discloses additional aspects of generating a training dataset from multiple quantum circuits and their executions in quantum computing systems;

FIG. 5 discloses aspects training a model;

FIG. 6A discloses aspects of inferring a clean signal, such as a probability distribution;

FIG. 6B discloses additional aspect of separating signal from noise; and

FIG. 7 discloses aspects of separating signal from noise in generating an estimated output of executing a quantum circuit in a quantum computing system.

### DETAILED DESCRIPTION OF SOME EXAMPLE EMBODIMENTS

Embodiments of the present invention generally relate to real and/or simulated quantum computing systems and to operations performed when executing quantum workloads. More particularly, at least some embodiments of the invention relate to systems, hardware, software, computer-readable media, and methods for orchestrating quantum jobs (i.e., quantum workloads) that may include quantum circuit(s). In order to determine the output of a quantum circuit, a large number of shots (circuit executions) is required. Embodiments of the invention relate to identifying the signal in the output of quantum executions more efficiently and with fewer shots. Embodiments of the invention relate to separating signal from noise in the output of quantum executions.

Quantum circuits may be executed in simulated quantum systems (e.g., virtual quantum systems or units (vQPUs)) that include classical computing components (e.g., processors, memory) or real quantum hardware systems or units (QPUs). The execution of quantum jobs often requires both classical computing systems and quantum computing systems because several operations are performed. Some of the operations are performed in classical computing systems and some of the operations are performed in quantum computing systems, whether real or simulated. Embodiments of the invention relate to orchestrating the operations performed in classical computing systems and in quantum computing systems. Although embodiments of the invention are discussed in the context of simulated and real quantum computing systems, embodiments of the invention more specifically relate to separating signal from noise in real quantum computing systems.

In one example, a quantum job, which includes a quantum circuit, may be received at an orchestration engine that is configured to orchestrate the execution of the quantum job. Orchestrating the execution of the quantum circuit includes performing actions or operations such as, but not limited to, transpilation operations, cutting operations, execution operations, and/or knitting operations. These operations are orchestrated as necessary and in the appropriate order.

Quantum execution refers to executing a quantum circuit by a quantum computing system. As previously stated, the number of times a quantum circuit is executed in order to obtain a clean or reasonably clean result or signal can be large and is often unknown prior to execution of the quantum circuit. Embodiments of the invention accelerate this process and relate to reducing the number of executions or shots required to separate the signal from the noise.

Embodiments of the invention estimate the probability distribution of a quantum circuit after fewer executions using a machine learning model, such as a diffusion model. In one example, a generative diffusion model architecture is configured to consider a combination of characteristics of the quantum circuit and the quantum computing system that will execute the quantum circuit in order to refine a noisy circuit output to a clean or sufficiently clean circuit output with fewer shots. Embodiments of the invention thus allow reliable results to be generated from comparatively fewer executions. Reducing the number of shots or executions can improve overall performance and reduce cost.

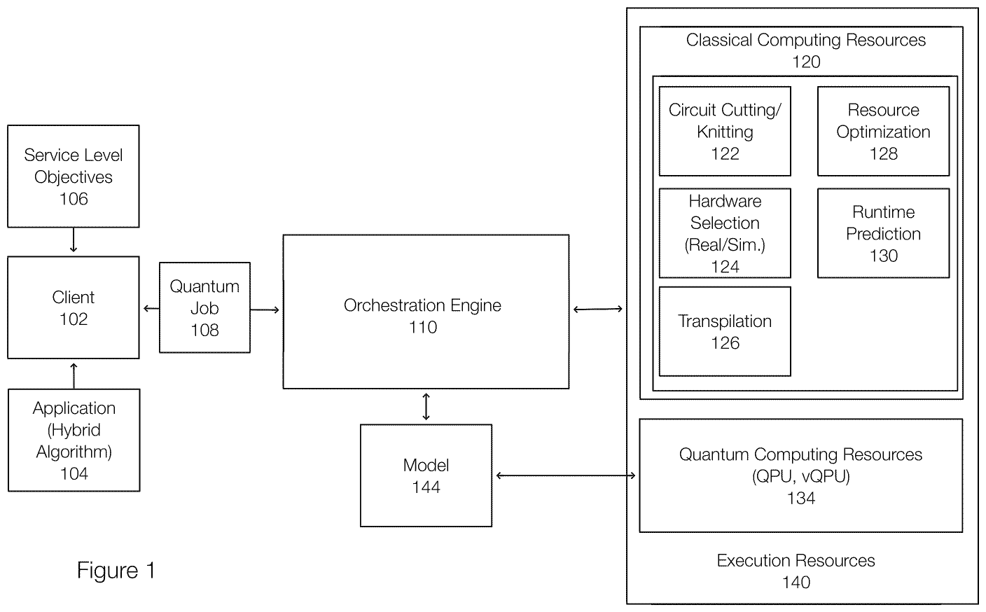

FIG. 1 discloses aspects of orchestrating a quantum job. In one example, a quantum job 108 may be generated by a hybrid application 104. The hybrid application 104 is an application that may require the use of execution resources 140, which includes both classical computing resources 120 and quantum computing resources 134. The orchestration of the quantum job 108 may be performed by an orchestration engine 110 and as previously stated, some aspects of the quantum job 108 may be executed in classical computing resources 120 and other aspects may be executed in quantum environments 134 (simulated or real). When quantum computing resources 134 are required, the hybrid application 104 may generate and submit a quantum job 108 to the orchestration engine 110. Results of executing the quantum job 108 may be returned to the client 102. Other aspects of the hybrid application 104 that do not require quantum computing may be performed in classical computing resources 120 with or without the aid of the orchestration engine.

More specifically, a client 102 (e.g., a computing device that may receive user input) may submit a quantum job 108, which may be associated with service level objectives 106 and a hybrid application 104, to an orchestration engine 110. The orchestration engine 110 is configured to orchestrate the execution of the quantum job 108 in accordance with the service level objectives 106.

The orchestration engine 110 may orchestrate the operations involved in executing the quantum job. The actions or operations orchestrated by the orchestration engine 110 may include circuit cutting/knitting 122 operations, resource optimization 128 operations, hardware selection 124 operation, runtime prediction 130 operations, transpilation 126 operations, or the like or combination thereof. The orchestration engine 110 may have access to the classical computing resources 120 (e.g., servers, nodes, containers, clusters, virtual machines) that include processors, memory, and the like and the quantum computing resources 134.

Orchestrating the execution of the quantum job 108 may include managing the stages of executing the quantum job. In effect, the orchestration engine 110 may guide the quantum job 108 through a quantum pipeline such that the output of each stage is directed to the input of the next stage. Examples of stages or operations that may be performed on a quantum job include, as previously stated, cutting, transpilation, knitting, resource optimization, runtime prediction, execution, signal extraction, or the like or combinations thereof.

Once the quantum circuit or quantum subcircuits are prepared for execution in a quantum computing system, these circuits are deployed to or placed in the quantum computing resources 134, which may be simulated or real. Embodiments of the invention may use a model 144 during execution of the quantum job 108 to reduce the number of executions of the quantum job 108 in the quantum computing resources 134. The results of executing the quantum circuits in the quantum computing resources 134 may also be collected by the orchestration engine 110 and returned to the client 102.

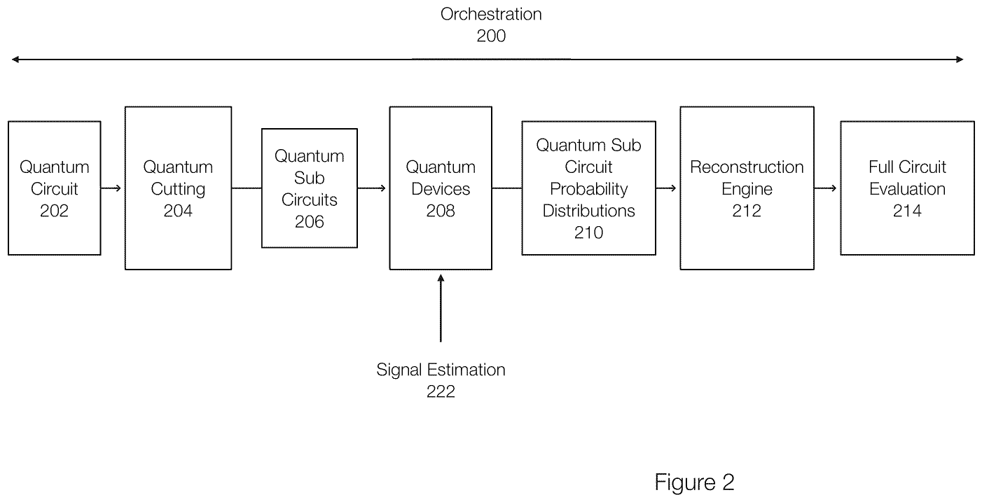

FIG. 2 discloses aspects of orchestrating the execution of a quantum circuit and illustrates examples of orchestration actions or operations. In FIG. 2, an orchestration engine performs orchestration 200 that may begin with receipt of a quantum job or circuit and end with providing results or output of executing the quantum circuit. As shown in FIG. 2, a quantum circuit 202 may be provided to quantum cutting 204 if cutting is desired or necessary.

Cutting 204 the quantum circuit 202 generates quantum subcircuits 206 that are executed at quantum devices 208 (real or simulated). Once the quantum subcircuits 206 are generated, runtime prediction (e.g., estimating resources required for the quantum subcircuits 206 and/or execution time) may be performed on each of the quantum subcircuits 206 such that resource optimization can be performed. Once an execution plan is generated that reflects the resource optimization, the quantum subcircuits 206 are submitted to the quantum devices 208 (real and/or simulated) in accordance with the execution plan.

The outputs of the executions may include quantum subcircuit probability distributions 210. In one embodiment, a machine learning model is configured to assist in executing the quantum circuits such that the probability distributions 210 can be generated from fewer shots or executions.

More specifically, executing a quantum circuit is often performed by executing the circuit in a quantum system for a number of shots that may be predetermined. The output of the quantum devices 208, without the signal estimation 222, is a collection of shot results which reflect a probability distribution. Embodiments of the invention incorporate signal estimation 222 to reduce the number of shots that would otherwise be required (or that may be specified) to obtain sufficiently clean or clear probability distributions 210. The output is sufficiently clean or clear as known to one of skill in the art. Thus, rather than performing all of the specified shots, the probability distributions 210 are estimated or predicted probability distributions 210 that are generated after performing a portion of or a smaller number of shots.

More specifically, a portion of the specified shots are performed using the quantum devices 208 and the output, after performing the portion of the specified shots, is a noisy signal or a noisy probability distribution. The aggregated output from the portion of the specified shots is then input recursively or iteratively to a machine learning model configured to generate a clean signal from a noisy signal. Thus, the signal estimation 222 uses a trained machine learning model to generate the estimated probability distributions 210 for each of the quantum subcircuits 206.

Next, a knitting operation is performed by a reconstruction engine 212 if the original quantum circuit was cut into smaller quantum circuits. The reconstruction engine 212 combines the outputs (e.g., the estimated probability distributions) of executing the quantum subcircuits 206 to determine the output (the estimated probability distribution) of the original quantum circuit 202. This allows an evaluation 214 of the full or original quantum circuit to be performed. The results, which may include the estimated probability distribution, or evaluation can be returned to the client or to the hybrid application.

Embodiments of the invention relate to estimating the probability distribution of a quantum job or circuit's outcome (e.g., the probability distribution) after performing a smaller number of shots than would otherwise be required. A diffusion model (DM) architecture may be used and/or altered to generate an estimate of the probability distribution and may consider a combination of characteristics of the quantum circuits and of the target quantum hardware that execute the quantum circuits so that a noisy output can be progressively refined into a clean output without having to execute the quantum circuit additional times. The large number of executions or shots that are conventionally required for a quantum system to produce reliable results from the execution of a quantum circuit can be substantially reduced while still achieving reliable results.

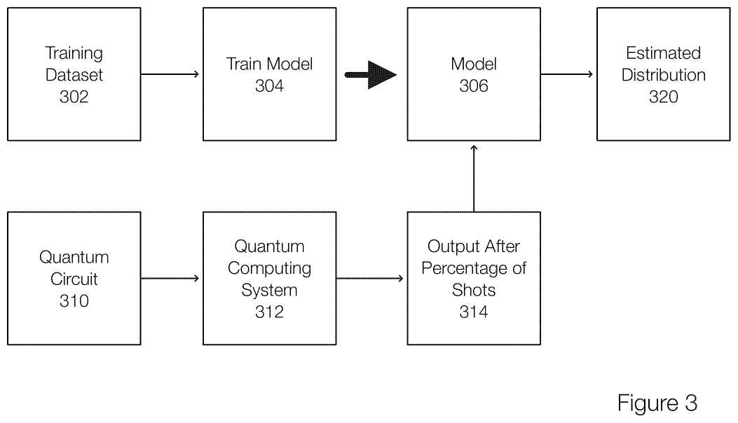

FIG. 3 discloses aspects of estimating the result or output of executing a quantum circuit. Embodiments of the invention relate to a model that is configured to generate a clean signal from a noisy signal. For example, executing a quantum circuit in a quantum computing system typically requires the circuit to be executed a large number of times due to the noise of the quantum computing system. A clean output is an example of a clean signal.

When a quantum circuit is submitted to a quantum computing system, the number of shots may be specified. Often hundreds or thousands of shots may be needed or performed to generate a sufficiently clean signal or output. Stated differently, the output of the quantum computing system after a low number of shots (e.g., less than the specified number of shots) is noisy and may not be reliable.

Embodiments of the invention advantageously reduce the number of shots required to generate a clean signal or a sufficiently clean signal by training the model to estimate or predict the clean signal from a noisy signal. This allows the clean signal to be generated using fewer shots. In one example, a model may be generated for each quantum computing system. Alternatively, the model may be configured or trained to account for the specific features of multiple quantum computing systems. Thus, the input may include features of the relevant quantum computing system.

A model is trained with a training dataset. In one example, the training dataset 302 may include markers. Each marker may represent an aggregate output of a quantum computing system after performing a portion of the specified shots. The markers, for example, may each be associated with a different number of shots. The first marker may correspond to the aggregated output after 10% of the shots, the second marker may correspond to the aggregated output after 20% of the shots, and so on.

Each marker can be associated with circuit features and/or device (the quantum computing system) features. For example, the features of the quantum computing system may change during execution of a quantum circuit. Thus, the features associated with one marker may differ from the features associated with a second marker for the same quantum circuit execution. For the training dataset 302, the circuit/device features may be aggregated with respect to the number of shots or with respect to the corresponding marker.

Once the training dataset 302 is generated, model training 304 is performed to generate the model 306. The model 306 is trained to, in effect, generate an estimate of a next marker from the current maker. Stated differently, the noisy signal is gradually changed using the model 306 to separate the clean signal from the noise signal. This process can be performed iteratively (e.g., provide the output of the model as the next input to the model). The model 306 is executed iteratively or recursively until the final estimated marker, which represents an estimate or prediction of a clean signal, is generated. Thus, the model 306 is trained to progressively generate cleaner versions of the input. The final output of the model 306 is an estimate of an output of the quantum computing system 312 if all shots were performed in one example.

Once the model 306 is trained, the model 306 may be used to generate inferences, estimates, or predictions. In FIG. 3, a quantum circuit 310 is submitted for execution to a quantum computing system 312. If n shots of the quantum circuit 310 were specified, the quantum circuit 310 may be executed up to the number of shots associated with the first marker. For example, if the first marker is associated with 10% of the shots, then n/10 shots are performed. The output after performing n/10 shots is the output after performing a percentage (or a predetermined portion) of the specified shots 314. The number of shots may also be determined without reference to the specified number of shots. Rather, embodiments of the invention may perform k shots.

The output 314 associated with the portion of shots is then input to the model 306. The model operates, starting with the output 314, recursively or iteratively until the model 306 predicts or estimates the marker associated with 100% of the shots. This corresponds to the estimated distribution 320 and is an example of separating a clean signal from a noisy signal. The model 306 receives the output 314, which is noisy, and progressively generates a cleaner output until the estimated distribution 320 is obtained.

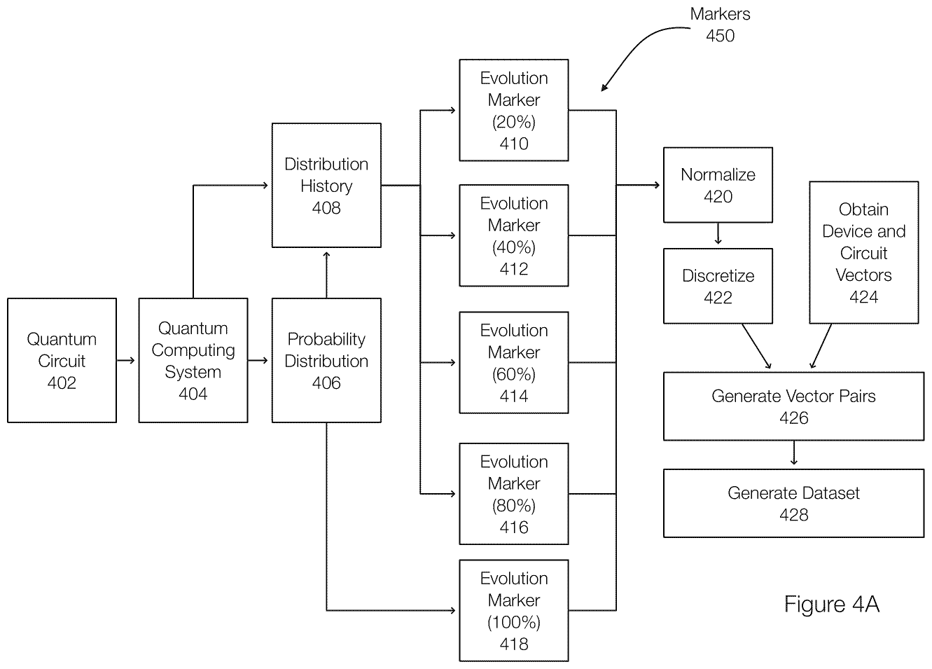

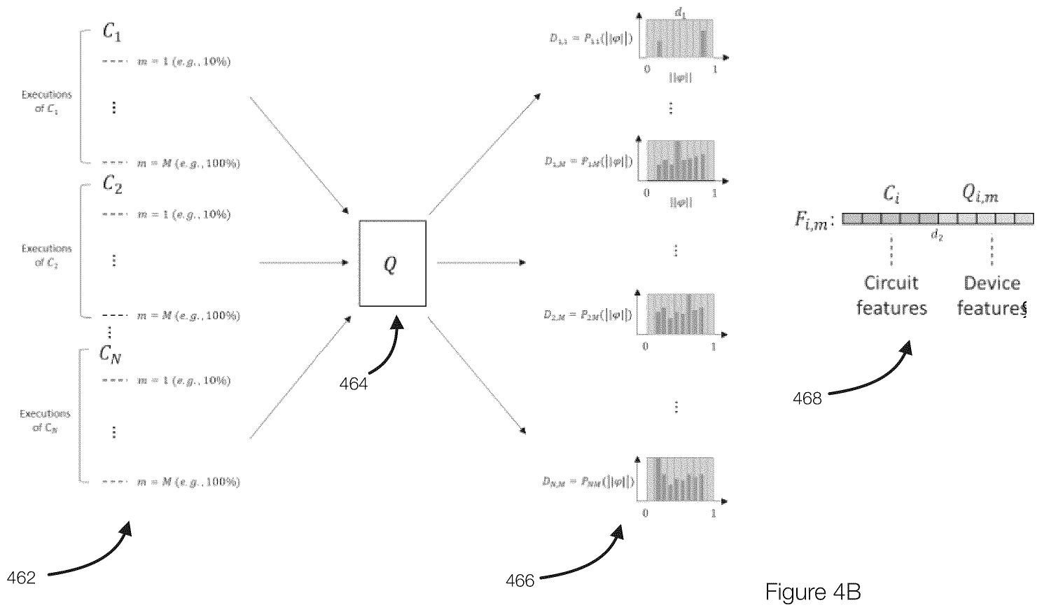

FIG. 4A discloses aspects of generating or creating a training dataset. FIG. 4A is described in the context of a single quantum circuit. However, the training dataset is generated from a set of N circuits. In FIG. 1, a quantum circuit 402 is executed on a quantum computing system 404. Each time a shot is executed, the output is stored in a distribution history 408. The final output of the quantum computing system 404 after executing 100% of the shots is a probability distribution 406 for the quantum circuit 402.

As the shots are performed and the distributions accumulate in the distribution history 408, markers 450 are generated. The markers 450 are examples of evolution markers as they represent the evolution of the output as more shots are performed. Thus, each of the markers 450 corresponds to a different aggregated output. The number of markers 450 can vary. FIG. 4A illustrates 5 markers at 20% intervals. However, additional (or fewer) markers can be generated.

By way of example, the marker 410 is generated when 20% of the shots have been performed. The marker 410 is generated by aggregating all of the shots up to 20% of the total shots. The probability distribution, at this stage, is likely to be noisy. Similarly, the marker 412 represents an aggregated probability distribution after 40% of the shots have been performed, the marker 414 represents an aggregated probability distribution after 60% of the shots have been performed, the marker 416 represented an aggregated probability distribution after 80% of the shots have been performed, and the marker 418 represents the output of the quantum computing system 404, or an aggregated probability distribution after 100% of the shots have been performed. The marker 418 may be the probability distribution 406 after performing all of the shots.

The markers 450 thus represent the probability distribution of circuit execution at different points of the circuit's execution. Next, the markers 450 are each normalized 420 into, in one example, a [0,1] interval. The normalized distributions are then discretized 422 into d₁ bins as a d₁-dimensional vectoral representation by way of example.

In preparing the training dataset, features of the quantum circuit 402 C₁ and of the quantum computing system 404 Q are obtained. The features of the quantum circuit 402 may include, by way of example only, the number of qubits, the depth, the adjacency matrix with CNOT connects between qubit pairs, and/or the like. Features of the quantum computing system 404 may include the adjacency matrix of physical qubit connections, calibration data (e.g., execution time, noise) of those physical qubits, and/or the like.

For each execution of the quantum circuit 402 (or for each of the markers), the features of the quantum circuit 402 and the features of the quantum computing system 404 are combined into a d₂-dimensional vectoral representation. Aggregate feature vectors are generated to match the M markers of the outputs. Thus, aggregate device (the quantum computing system 404) and circuit (quantum circuit 402) vectors 424 are generated for each of the markers 450.

Next, vector pairs 426 are generated. More specifically, for each circuit execution marker m, an input vector pair {F_{i,m}, D_{i,m}} is generated. F_{i,m} is the m^{th} aggregate representation of circuit features and device features and D_{i,m} is the m^{th} aggregate output distribution. Each of the input vector pairs is mapped to the next output marker D_{i,m+1}.

Next, the dataset 428, which is an example of a training dataset, with N×M samples ({F_{i,m}, D_{i,m}}→D_{i,m+1}), is generated. The dataset 428 thus includes or represents M execution markers for each of N circuits.

FIG. 4B discloses aspects of generating aggregated distributions. FIG. 4B illustrates N quantum circuits (C₁ . . . C_{N}) that are executed in a quantum computing system 464 (Q). Assuming that each of the N quantum circuits were executed for a certain number of shots, markers 466 are generated. More specifically, the markers 466 include M markers for each of the N quantum circuits. Each of the M markers correspond to different points of circuit execution for each of the N circuits. Thus, a set of M markers is generated for each of the circuits. More specifically, the first quantum circuit is associated with markers D_{1,1} . . . D_{1,M}. The second quantum circuit is associated with markers D_{2,1} . . . D_{2,M}, and the N^{th} quantum circuit is associated with markers D_{N,1} . . . D_{N,M}. The markers 466 can be associated with the vectors 468 associated with the circuit and device features to generate the vector pairs {F_{i,m}, D_{i,m}}.

From a more general perspective, in one example, a set of N circuits, Cᵢ, is executed on some quantum computing device or system Q. Each circuit, Cᵢ, is executed as many times as required (or a prescribed number) until a (reasonably) clean probability distribution of the circuits output states is obtained. In one example, every output of the quantum system is collected.

A fixed number, M, of output evolution markers (e.g., at 10%, 20%, etc., of the executions) is established and an aggregate distribution for each of the evolution markers is generated. The domain of the aggregate distributions is normalized into the [0, 1] interval to be invariant to the number of outputs (qubit states) of the circuits. The normalized distributions are discretized into d₁ bins, as a d₁-dimensional vectorial representation (embedding).

Features of each circuit Cᵢ and of the quantum device Q are obtained. Features of Cᵢ may include the number of qubits, the depth, the adjacency matrix with CNOT connections between qubit pairs, or the like or combination thereof. Features of Q may include the adjacency matrix of physical qubit connections, calibration data (e.g., execution time, noise) of those physical qubits, or the like or combination thereof. For each execution of Cᵢ, circuit and device or system features (considering updated calibration data) are combined into a d₂-dimensional vectorial representation. Aggregate vectors match the M evolution markers of the outputs.

For each circuit execution marker m an input pair {F_{i,m}, D_{i,m}}, is made or generated where F_{i,m} is the m^{th} aggregate representation of circuit and device features and D_{i,m} is the m^{th} aggregate output distribution, to an output marker D_{i,m+1}, which is the next aggregate output distribution.

This data is included in a dataset with N×M samples, {F_{i,m}, D_{i,m}}→D_{i,m+1} including M execution markers of N circuits.

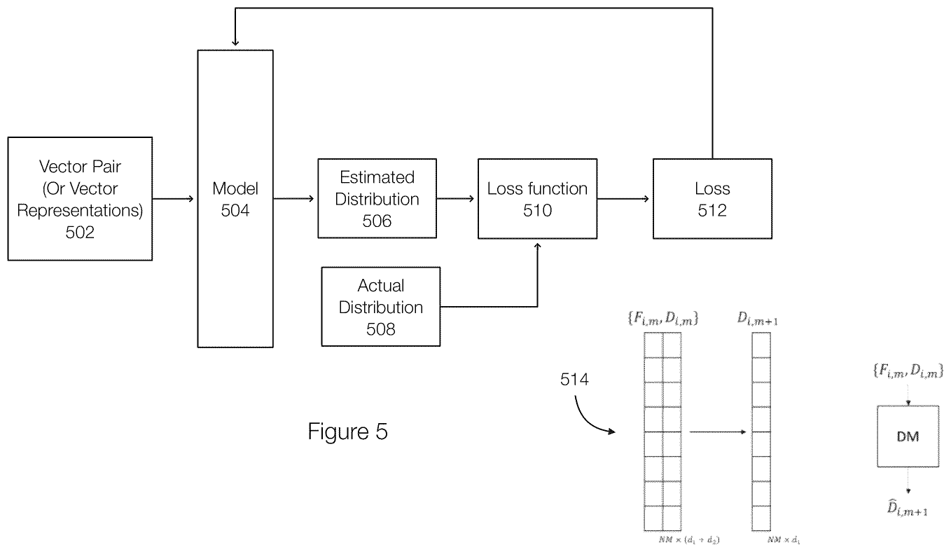

FIG. 5 discloses aspects of training a model to generate a clean signal or a clean output (or sufficiently clean) from a noisy signal or from noisy input. Training the model includes in one example, inputting a vector pair or vector representations 502 to the model 504. The model generates an output, which may be an estimated distribution 506. More specifically, the input 502 corresponds to a marker and the output 506 is an estimate of the next marker. During training, a loss function 510 may determine a loss 512 between the estimated distribution 506 and the actual distribution 508 (e.g., from the training dataset) that is used to improve the operation of the model 504.

In this example, the model 504 learns the relationship of:

{F_{i,m},D_{i,m}}→D_{i,m+1},∀m∈[0,M−1].

More specifically, the model 504 may receive the vectorial representations 502 of the circuit features and the devices features plus a vectorial representation of an output distribution at execution marker m and estimate a distribution for the marker m+1 of \hat{D}_{i,m+1}. In one example, the loss function 501 is a Kullback-Liebler divergence (KL) and the loss 512 is loss=KL(\hat{D}_{i,m+1}, D_{i,m+1}). The operation of the model 504 with respect to the vectorial representations is illustrated at 514.

Once the model 504 is trained, the model 504 may be deployed for operation. Thus, the model, upon receiving a particular input, may generate an inference or estimate of the final output distribution of a quantum computing system without performing the number of shots that would otherwise be required.

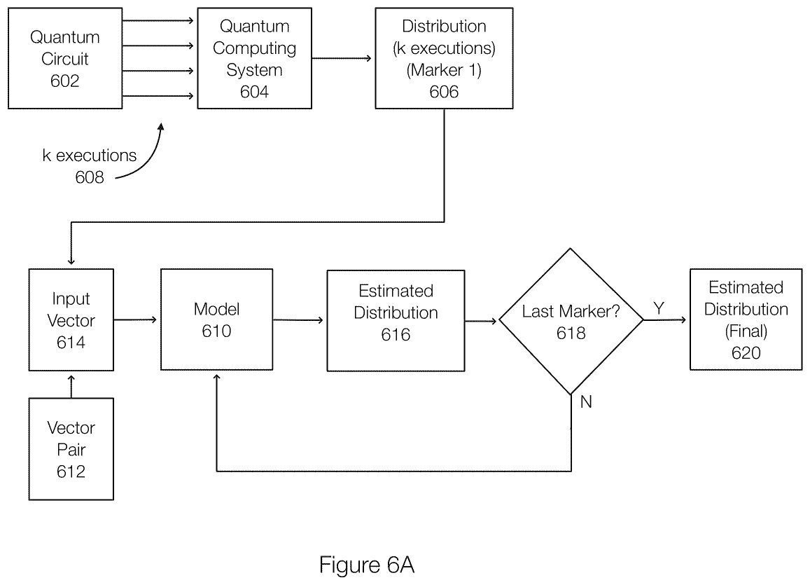

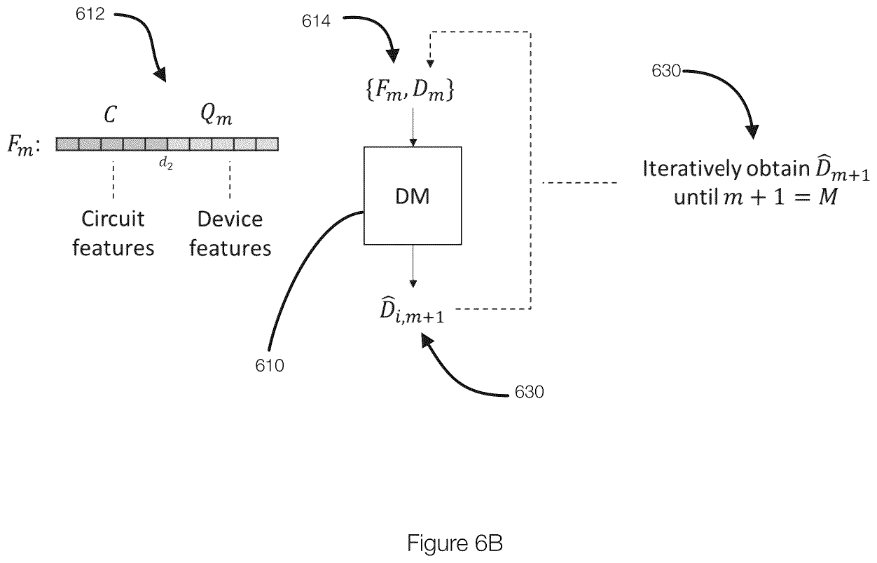

FIG. 6A discloses aspects of inferring an output, such as a probability distribution. In FIG. 6, a quantum circuit 602 is received. An application that submitted the quantum circuit 602 for execution may also specify a number of shots n. In this example, the quantum circuit 602 is executed on the quantum computing system 605 for k (k<n) executions 608. The aggregated output of the k executions 608 is an example of a distribution 606. The distribution 606 corresponds to marker 1 of M markers in this example. In other words, for the k executions, the distribution of the quantum sates is collected, normalized to the [0,1] interval and discretized into d₁ bins.

During the k executions, features (F_{C}) of the quantum circuit 602 are collected. The features (F_{C}) may be collected in a manner similar to how the features are collected when the dataset is generated. In addition, for each of the k executions, features and calibration data (F_{Q}) are collected from the quantum computing system 604.

Thus, at the first execution marker (m=1), the device features F_{Qm} and the discretized distributions Dₘ are aggregated and combined into a d₂ dimensional vector pair 612: Fₘ={F_{C}, F_{Qm}}.

Next, F m and D m are concatenated into an input vector 614 that is provided as input to a model 610. The model has been trained to predict the distribution associated with the next marker 616. If the estimated distribution 616 corresponds to the final marker (& at 618), then the output of the model 610 is the final estimated distribution 620. If the output of the model 610, the estimated distribution 616, is not associated with the last marker, then the estimated distribution 616 is input to the model 610 and the output (a new estimated distribution) is generated that is associated with the next marker.

FIG. 6B discloses aspects of estimating a probability distribution. Fₘ and Dₘ are concatenated into a single vector 612 and provided as input 614 to the trained model 610 so that the model 610 generates an estimate \hat{D}ₘ₊₁ of the distribution of the output quantum states at the next execution marker, m+1.

Dₘ is replaced with \hat{D}ₘ₊₁ and \hat{D}ₘ₊₁ and the updated input vector (now {Fₘ, \hat{D}ₘ₊₁} is provided to the trained model 610 to obtain an estimate \hat{D}ₘ₊₂. This step is repeated iteratively 630 until \hat{D}ₘ₊ᵢ=\hat{D}_{M}, as an estimate of the final distribution 620 of quantum states at the last execution marker, M.

The inverse of normalization function is applied to obtain the distribution of the output quantum states of the circuit C.

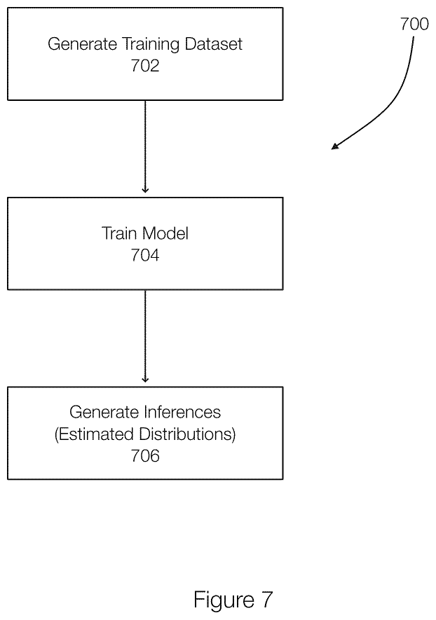

FIG. 7 discloses aspects of separating a signal from noise. The method 700 illustrates a method for separating a clean signal from a noisy signal in the context of executing a quantum circuit in a quantum computing system. The method 700 is generally illustrated via stages described herein: database generation; model training; and inference. Thus, the method 700 illustrates stages that can be performed separately and independently of each other.

Initially, a training dataset is generated 702. The dataset is generated to include the distributions associated with executing quantum circuits. The data generated from each executed circuit includes an aggregated distribution at different markers. The markers allow vectors representing the output of the quantum computing system, circuit features, and device features to be used as input to generate an output corresponding to the next marker.

Once a dataset is prepared, the model is trained 704 with the dataset. Thus, the model learns to gradually generate a clean signal from a noisy signal in steps that are learned from the markers used to train the model.

Once the model is trained, inferences may be generated 706. When a quantum circuit is submitted for execution, a portion of the shots are executed to obtain an initial aggregated output. This initial output of the quantum computing system may correspond to an initial marker. Execution of the circuit in the quantum computing system is then terminated and the output of the quantum computing system is inferred by iteratively inputting the output of the quantum computing system into the model. After multiple iterations, an estimated probability distribution or output is obtained.

Embodiments of the invention generate clean quantum state distribution estimates from fewer circuit executions. This can reduce the number of circuit executions that would otherwise be required to generate a suitable output distribution.

Embodiments of the invention relate to using a model, such as a diffusion model, to estimate quantum state distributions of quantum circuits after a small number of circuit executions. A combination of circuit and quantum device features capture their specificities and association with quantum state distributions. Normalizing and discretizing the quantum stat distributions allows them to be invariant to the number of output stages of a quantum circuit. Aggregating the quantum circuit executions into execution markers allows them to be invariant to the total number of executions for different quantum circuits.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, hybrid-classical application operations, quantum circuit operations, quantum circuit execution operations, quantum circuit cutting operations, resource consumption estimation operations, quantum circuit knitting operations, telemetry operations, machine learning model operations (e.g., that generate predictions or inferences), modelling operations, probability distribution related operations, marking operations, inference operations, sampling operations, or the like or combination thereof. These operations may, in some examples, be referred to as quantum operations.

Example cloud computing environments, which may or may not be public, include storage environments that may provide functionality for one or more clients or systems. Another example of a cloud computing environment is one in which quantum operations and/or quantum services may be performed on behalf of one or more clients, applications, or users. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment. The cloud environment may also include quantum environments including vQPUs, QPU, other accelerators, or the like.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data or circuits. Such clients may comprise physical machines, containers, or virtual machines (VMs).

Particularly, devices in the operating environment, such as classical components of hybrid classical-quantum systems, may take the form of software, physical machines, containers, or VMs, or any combination of these, though no particular device implementation or configuration is required for any embodiment. Similarly, data storage system components such as databases, storage servers, storage volumes (LUNs), storage disks, replication services, backup servers, restore servers, backup clients, and restore clients, for example, may likewise take the form of software, physical machines, containers, or virtual machines (VM), though no particular component implementation is required for any embodiment.

It is noted that any operation(s) of any of these methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in anyway.

Embodiment 1. A method comprising: receiving a quantum circuit at an orchestration engine, wherein the quantum circuit is associated with a specified number of n shots, performing k shots of the quantum circuit in a quantum computing system, wherein k is less than n, to generate an output of the quantum computing system, inputting the output into a model configured to generate a clean output from a noisy input to generate a model output, and generating an estimated final output of the quantum circuit by iteratively providing the model output of the model as the input a determined number of times, wherein the estimated final output is an estimated probability distribution associated with execution of the quantum circuit.

Embodiment 2. The method of embodiment 1, further comprising generating a training dataset to train the model.

Embodiment 3. The method of embodiment 1 and/or 2, further comprising executing a set of quantum circuits on the quantum computing system.

Embodiment 4. The method of embodiment 1, 2, and/or 3, generating a set of markers for each of the quantum circuits in the set of quantum circuits, wherein each of the markers includes an aggregated output of a portion of the n shots, wherein each of the markers is associated with a different aggregated portion.

Embodiment 5. The method of embodiment 1, 2, 3, and/or 4, further comprising normalizing and discretizing each of the markers.

Embodiment 6. The method of embodiment 1, 2, 3, 4, and/or 5, further comprising generating a vector pair for each of the quantum circuits that includes features of the quantum circuit and features of the quantum computing system.

Embodiment 7. The method of embodiment 1, 2, 3, 4, 5, and/or 6, further comprising training the model with the training data set to learn a relationship of {F_{i,m}, D_{i,m}}→D_{i,m+1}, ∀m∉[0,M−1], wherein F_{i,m}, includes the features of the quantum circuit and the features of the quantum computing system and D_{i,m} represents an output distribution at marker m.

Embodiment 8. The method of embodiment 1, 2, 3, 4, 5, 6, and/or 7, further comprising performing an inverse normalization function on the estimated final output to determine output quantum states of the quantum circuit.

Embodiment 9. The method of embodiment 1, 2, 3, 4, 5, 6, 7, and/or 8, further comprising, at a first marker that corresponds to the k shots, collecting features of the quantum circuit and features of the quantum computing system.

Embodiment 10. The method of embodiment 1, 2, 3, 4, 5, 6, 7, 8, and/or 9, further comprising wherein the model is invariant to a number of output states of the quantum circuit.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-11.

Embodiment 13. A system comprising a processor and memory configured to perform the operations, methods, or processes, or any portion of any of these, or any combination thereof disclosed herein.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, engine, or agent, may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, herein, may take the form of, or include, or be implemented on, or hosted by, a physical computing device. As well, where any of the aforementioned elements comprise or consist of a virtual machine (VM) or a container, that VM or container may constitute a virtualization of any combination of the physical components disclosed herein.

In a physical computing device includes a memory which may include one, some, or all, of random-access memory (RAM), non-volatile memory (NVM) such as NVRAM for example, read-only memory (ROM), and persistent memory, one or more hardware processors, non-transitory storage media, UI device, and data storage. One or more of the memory components of the physical computing device may take the form of solid-state device (SSD) storage. As well, one or more applications may be provided that comprise instructions executable by one or more hardware processors to perform any of the operations, or portions thereof, disclosed herein. The physical device may be an example of a classical computing system that may be part of a hybrid computing system. A quantum processing system or unit may also be included in the hybrid computing system.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a quantum circuit at an orchestration engine, wherein the quantum circuit is associated with a specified number of n shots;
performing k shots of the quantum circuit in a quantum computing system, wherein k is less than n, to generate an output of the quantum computing system;
inputting the output into a model configured to generate a clean output from a noisy input to generate a model output; and
generating an estimated final output of the quantum circuit by iteratively providing the model output of the model as the input a determined number of times, wherein the estimated final output is an estimated probability distribution associated with execution of the quantum circuit.

2. The method of claim 1, further comprising generating a training dataset to train the model.

3. The method of claim 2, further comprising executing a set of quantum circuits on the quantum computing system.

4. The method of claim 3, generating a set of markers for each of the quantum circuits in the set of quantum circuits, wherein, each of the markers includes an aggregated output of a portion of the n shots, wherein each of the markers is associated with a different aggregated portion.

5. The method of claim 4, further comprising normalizing and discretizing each of the markers.

6. The method of claim 5, further comprising generating a vector pair for each of the quantum circuits that includes features of the quantum circuit and features of the quantum computing system.

7. The method of claim 6, further comprising training the model with the training data set to learn a relationship of {F_{i,m}, D_{i,m}}→D_{i,m+1}, ∀m∈[0,M−1], wherein F_{i,m} includes the features of the quantum circuit and the features of the quantum computing system and D_{i,m} represents an output distribution at marker m.

8. The method of claim 1, further comprising performing an inverse normalization function on the estimated final output to determine output quantum states of the quantum circuit.

9. The method of claim 1, further comprising, at a first marker that corresponds to the k shots, collecting features of the quantum circuit and features of the quantum computing system.

10. The method of claim 1, further comprising wherein the model is invariant to a number of output states of the quantum circuit.

11. A non-transitory storage medium having stored therein instructions that are executable by one or more hardware processors to perform operations comprising:
receiving a quantum circuit at an orchestration engine, wherein the quantum circuit is associated with a specified number of n shots;
performing k shots of the quantum circuit in a quantum computing system, wherein k is less than n, to generate an output of the quantum computing system;
inputting the output into a model configured to generate a clean output from a noisy input to generate a model output; and
generating an estimated final output of the quantum circuit by iteratively providing the model output of the model as the input a determined number of times, wherein the estimated final output is an estimated probability distribution associated with execution of the quantum circuit.

12. The non-transitory storage medium of claim 11, further comprising generating a training dataset to train the model.

13. The non-transitory storage medium of claim 12, further comprising executing a set of quantum circuits on the quantum computing system.

14. The non-transitory storage medium of claim 13, generating a set of markers for each of the quantum circuits in the set of quantum circuits, wherein each of the markers includes an aggregated output of a portion of the n shots, wherein each of the markers is associated with a different aggregated portion.

15. The non-transitory storage medium of claim 14, further comprising normalizing and discretizing each of the markers.

16. The non-transitory storage medium of claim 15, further comprising generating a vector pair for each of the quantum circuits that includes features of the quantum circuit and features of the quantum computing system.

17. The non-transitory storage medium of claim 16, further comprising training the model with the training data set to learn a relationship of {F_{i,m}, D_{i,m}}→D_{i,m+1}, ∀m∈[0,M−1], wherein F_{i,m} includes the features of the quantum circuit and the features of the quantum computing system and D_{i,m} represents an output distribution at marker m.

18. The non-transitory storage medium of claim 11, further comprising performing an inverse normalization function on the estimated final output to determine output quantum states of the quantum circuit.

19. The non-transitory storage medium of claim 11, further comprising, at a first marker that corresponds to the k shots, collecting features of the quantum circuit and features of the quantum computing system.

20. The non-transitory storage medium of claim 11, further comprising wherein the model is invariant to a number of output states of the quantum circuit.
